(19) United States
(12) Patent Application Publication
(10) Pub. No.: US 2024/0054621 A1
(43) Pub. Date: Feb. 15, 2024

(54) REMOVING REFLECTION ARTIFACTS FROM POINT CLOUDS

(71) Applicant: FARO Technologies, Inc., Lake Mary, FL (US)

(72) Inventors: Raza Ul Azam, Ludwigsburg (DE); Mathieu Dube-Dallaire, Montreal (CA); Daniel Pompe, Leonberg (DE); Vitaliy Ostapchuk, Stuttgart (DE); Sagar Kalburgi, Aachen (DE)

(21) Appl. No.: 18/356,864

(22) Filed: Jul. 21, 2023

Related U.S. Application Data
(60) Provisional application No. 63/396,731, filed on Aug. 10, 2022.

(51) Int. Cl. G06T 5/00; G06T 17/00; G06T 7/50

(52) U.S. Cl. CPC G06T 5/005; G06T 17/00; G06T 7/50; G06T 2210/12; G06T 2207/10028

(57) ABSTRACT

A computer-implemented method is provided that includes detecting at least one reflective surface in at least one two-dimensional (2D) image of an environment. The method further includes generating bounding coordinates encompassing the at least one reflective surface in the 2D image. The method further includes projecting the bounding coordinates of the 2D image into a three-dimensional (3D) space of the environment. The method further includes identifying a reflection artifact encompassed by the bounding coordinates in the 3D space. The method further includes removing the reflection artifact identified in the bounding coordinates.

### CROSS-REFERENCE OF RELATED APPLICATIONS

This application claims the benefit of U.S. Provisional Patent Application Ser. No. 63/396,731, filed Aug. 10, 2022, entitled “REMOVING REFLECTION ARTIFACTS FROM POINT CLOUDS,” the contents of which are incorporated by reference herein in their entirety.

### BACKGROUND

The subject matter disclosed herein relates to use of a three-dimensional (“3D”) measurement device, such as a laser scanner time-of-flight (TOF) coordinate measurement device. A 3D laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A time-of-flight (TOF) laser scanner is a scanner in which the distance to a target point is determined based on the speed of light in air between the scanner and a target point. Laser scanners are typically used for scanning closed or open spaces such as interior areas of buildings, industrial installations and tunnels. They may be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Generating an image requires at least three values for each data point. These three values may include the distance and two angles, or may be transformed values, such as the x, y, z coordinates.

Most TOF scanners direct the beam of light within the measurement volume by steering the light with a beam steering mechanism. The beam steering mechanism includes a first motor that steers the beam of light about a first axis by a first angle that is measured by a first angular encoder (or other angle transducer). The beam steering mechanism also includes a second motor that steers the beam of light about a second axis by a second angle that is measured by a second angular encoder (or other angle transducer). As a result of the scan, a collection of 3D coordinates is generated for points on surfaces in the environment. This collection of 3D coordinates is sometimes referred to as a “point cloud.” In many applications, multiple scans may be performed in an environment to acquire the desired measurements.

Many contemporary laser scanners include a camera mounted on the laser scanner for gathering camera digital images of the environment and for presenting the camera digital images to an operator of the laser scanner. By viewing the camera images, the operator of the scanner can determine the field of view of the measured volume and adjust settings on the laser scanner to measure over a larger or smaller region of space. In addition, the camera digital images may be transmitted to a processor to add color to the scanner image. To generate a color scanner image, at least three positional coordinates (such as x, y, z) and three color values (such as red, green, blue “RGB”) are collected for each data point.

When generating the point cloud, artifacts (i.e., aberrations) can be unintendedly captured by the TOF scanner. This may occur for example, when one or more scans are performed with an area of overlap. Removing artifacts from the point cloud is usually performed in a manual operation. Having individuals correct the resulting point cloud is therefore tedious and time consuming.

Accordingly, while existing 3D scanners and image processing techniques are suitable for their intended purposes, what is needed is further image processing having certain features of embodiments of the present invention.

### BRIEF SUMMARY OF THE INVENTION

According to one or more embodiments, a computer-implemented method is provided. The computer-implemented method includes detecting at least one reflective surface in at least one two-dimensional (2D) image of an environment, generating bounding coordinates encompassing at least one reflective surface in the 2D image, and projecting the bounding coordinates of the 2D image into a three-dimensional (3D) space of the environment. The computer-implemented method includes identifying at least one reflection artifact encompassed by the bounding coordinates in the 3D space and removing the reflection artifact identified in the bounding coordinates.

In addition to one or more of the features described herein, or as an alternative, further embodiments of the method may include wherein an artificial intelligence (AI) model is trained to detect the at least one reflection artifact and generate the bounding coordinates encompassing at least one reflective surface.

In addition to one or more of the features described herein, or as an alternative, further embodiments of the method may wherein the AI model is trained on a dataset of a plurality of 2D images, the plurality of 2D images comprising a plurality of bounding coordinates respectively encompassing a plurality of reflective surfaces.

In addition to one or more of the features described herein, or as an alternative, further embodiments of the method may include wherein removing the reflection artifact identified in the bounding coordinates comprises: selecting candidate 3D points encompassed by the bounding coordinates in the 3D space, clustering the candidate 3D points by intensity values or reflectance values, and selecting at least one of the 3D points as the reflection artifact based at least in part on a threshold associated with the intensity values or the reflectance values.

In addition to one or more of the features described herein, or as an alternative, further embodiments of the method may include wherein removing the reflection artifact identified in the bounding coordinates comprises: selecting candidate 3D points encompassed by the bounding coordinates in the 3D space, clustering the candidate 3D points by depth values, and selecting at least one of the 3D points as the reflection artifact based at least in part on a threshold associated with the depth values.

In addition to one or more of the features described herein, or as an alternative, further embodiments of the method may include wherein removing the reflection artifact identified in the bounding coordinates comprises: fit a plane on the bounding coordinates by using a normal vector of a center point of the bounding coordinates, find a maximum depth within the bounding coordinates, and fit a rectangular volume using the maximum depth.

In addition to one or more of the features described herein, or as an alternative, further embodiments of the method may include wherein the 2D image is a panorama image.

In addition to one or more of the features described herein, or as an alternative, further embodiments of the method may include wherein the 3D space is a 3D point cloud that is registered with at least one other 3D point cloud of the environment.

According to one or more embodiments, a system is provided. The system includes a memory having computer readable instructions and one or more processors for executing the computer readable instructions. The computer readable instructions control the one or more processors to perform operations. The operations include detecting at least one reflective surface in at least one two-dimensional (2D) image of an environment. The operations further include generating bounding coordinates encompassing the at least one reflective surface in the 2D image. The operations further include projecting the bounding coordinates of the 2D image into a three-dimensional (3D) space of the environment. The operations further include identifying a reflection artifact encompassed by the bounding coordinates in the 3D space. The operations further include removing the reflection artifact identified in the bounding coordinates.

In addition to one or more of the features described herein, or as an alternative, further embodiments of the system may include that an artificial intelligence (AI) model is trained to detect the at least one reflection artifact and generate the bounding coordinates encompassing the at least one reflective surface.

In addition to one or more of the features described herein, or as an alternative, further embodiments of the system may include that the AI model is trained on a dataset of a plurality of 2D images, the plurality of 2D images comprising a plurality of bounding coordinates respectively encompassing a plurality of reflective surfaces.

In addition to one or more of the features described herein, or as an alternative, further embodiments of the system may include that removing the reflection artifact identified in the bounding coordinates comprises: selecting candidate 3D points encompassed by the bounding coordinates in the 3D space; clustering the candidate 3D points by intensity values or reflectance values; and selecting at least one of the candidate 3D points as the reflection artifact based at least in part on a threshold associated with the intensity values or the reflectance values.

In addition to one or more of the features described herein, or as an alternative, further embodiments of the system may include that removing the reflection artifact identified in the bounding coordinates comprises: selecting candidate 3D points encompassed by the bounding coordinates in the 3D space; clustering the candidate 3D points by depth values; selecting at least one of the candidate 3D points as the reflection artifact based at least in part on a threshold associated with the depth values.

In addition to one or more of the features described herein, or as an alternative, further embodiments of the system may include that removing the reflection artifact identified in the bounding coordinates comprises: fit a plane on the bounding coordinates by using a normal vector of a center point of the bounding coordinates; find a maximum depth within the bounding coordinates; and fit a rectangular volume using the maximum depth.

In addition to one or more of the features described herein, or as an alternative, further embodiments of the system may include that the 2D image is a panorama image.

In addition to one or more of the features described herein, or as an alternative, further embodiments of the system may include that the 3D space is a 3D point cloud that is registered with at least one other 3D point cloud of the environment.

According to one or more embodiments, a computer program product is provided that includes a computer readable storage medium having program instructions embodied therewith, the program instructions executable by one or more processors to cause the one or more processors to perform operations. The operations include detecting at least one reflective surface in at least one two-dimensional (2D) image of an environment. The operations further include generating bounding coordinates encompassing the at least one reflective surface in the 2D image. The operations further include projecting the bounding coordinates of the 2D image into a three-dimensional (3D) space of the environment. The operations further include identifying a reflection artifact encompassed by the bounding coordinates in the 3D space. The operations further include removing the reflection artifact identified in the bounding coordinates.

In addition to one or more of the features described herein, or as an alternative, further embodiments of the computer program product may include that an artificial intelligence (AI) model is trained to detect the at least one reflection artifact and generate the bounding coordinates encompassing the at least one reflective surface.

In addition to one or more of the features described herein, or as an alternative, further embodiments of the computer program product may include that the AI model is trained on a dataset of a plurality of 2D images, the plurality of 2D images comprising a plurality of bounding coordinates respectively encompassing a plurality of reflective surfaces.

In addition to one or more of the features described herein, or as an alternative, further embodiments of the computer program product may include that removing the reflection artifact identified in the bounding coordinates comprises: selecting candidate 3D points encompassed by the bounding coordinates in the 3D space; clustering the candidate 3D points by intensity values or reflectance values; and selecting at least one of the candidate 3D points as the reflection artifact based at least in part on a threshold associated with the intensity values or the reflectance values.

These and other advantages and features will become more apparent from the following description taken in conjunction with the drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a laser scanner in accordance with an embodiment of the invention;

FIG. 2 is a side view of the laser scanner illustrating a method of measurement according to an embodiment;

FIG. 3 is a schematic illustration of the optical, mechanical, and electrical components of the laser scanner according to an embodiment;

FIG. 4 is a schematic illustration of the laser scanner of FIG. 1 according to an embodiment;

FIG. 5 is a block diagram of an example computer system for use in conjunction with one or more embodiments;

FIG. 6 is a block diagram of a computer system for automatically removing reflection artifacts from a three-dimensional (3D) image according to one or more embodiments;

FIG. 7 is a flowchart of a computer-implemented method for training an artificial intelligence (AI) model for detecting and generating a bounding box around reflective surfaces according to one or more embodiments;

FIG. 8 is a flowchart of a computer-implemented method for automatically removing reflection artifacts from a 3D image according to one or more embodiments;

FIG. 9 illustrates an example color image having reflective surfaces labeled with a bounding box according to one or more embodiments;

FIG. 10 illustrates an example color image having reflective surfaces labeled with a bounding box according to one or more embodiments;

FIG. 11 illustrates an example of a color image and its intensity information (e.g., a grayscale/reflectance image) input to the AI model which is used to generate bounding boxes in the color image according to one or more embodiments;

FIG. 12 illustrates an example reflectance image highlighting a bounding box encompassing a window according to one or more embodiments;

FIG. 13A illustrates that reflection points or artifacts are identified for removal from the window in FIG. 12 according to one or more embodiments;

FIG. 13B illustrates that the identified reflection points or artifacts in FIG. 13A are removed from the 3D point cloud according to one or more embodiments; and

FIG. 14 is flowchart of a computer-implemented method for automatically removing reflection artifacts from a 3D image using a 2D image according to one or more embodiments.

The detailed description explains embodiments of the invention, together with advantages and features, by way of example with reference to the drawings.

### DETAILED DESCRIPTION

One or more embodiments of the present invention relate to removing reflection artifacts from point clouds, and more specifically, to using artificial intelligence (AI) to detect reflective surfaces in 2D images and removing reflection artifacts corresponding to the reflective surfaces from point clouds. Embodiments of the invention provide advantages in generating 3D coordinate data generated by filtering reflection artifacts in 3D coordinate data in which the reflection artifacts are created by reflective surfaces in scanned data. In one or more embodiments, reflective surfaces are detected in images using machine learning, such as artificial neural networks including deep neural networks, convolutional neural networks, etc. The 3D points in a point cloud corresponding to the reflective surfaces are identified and removed, thereby resulting in a 3D point cloud free of reflection artifacts. Reflection artifacts or reflective 3D data points may be the noisy/unwanted 3D data points reflected on a reflective surface and/or through the reflective surface. Examples of typical reflective surfaces may include but are not limited to windows, windshield, mirrors, glass surfaces, glass-like surfaces, metallic surfaces, water, etc. In general, a reflective surface can return or bounce back light as well as permit images through/beyond the reflective surface to be viewed and captured by a scanning device.

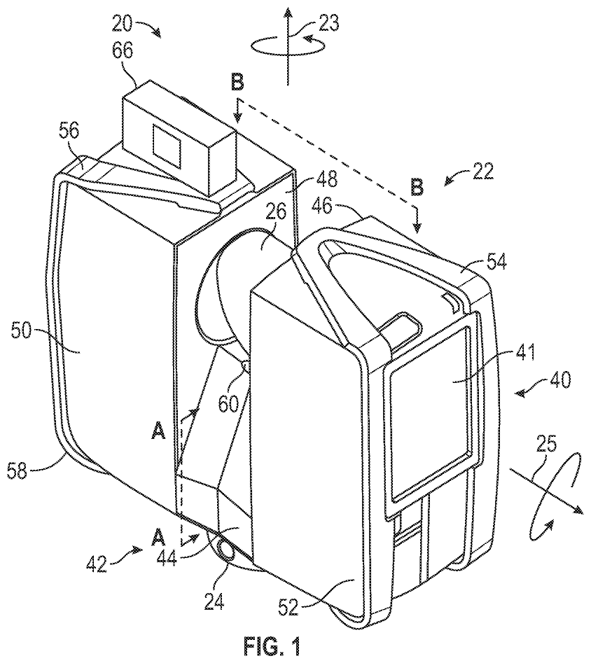

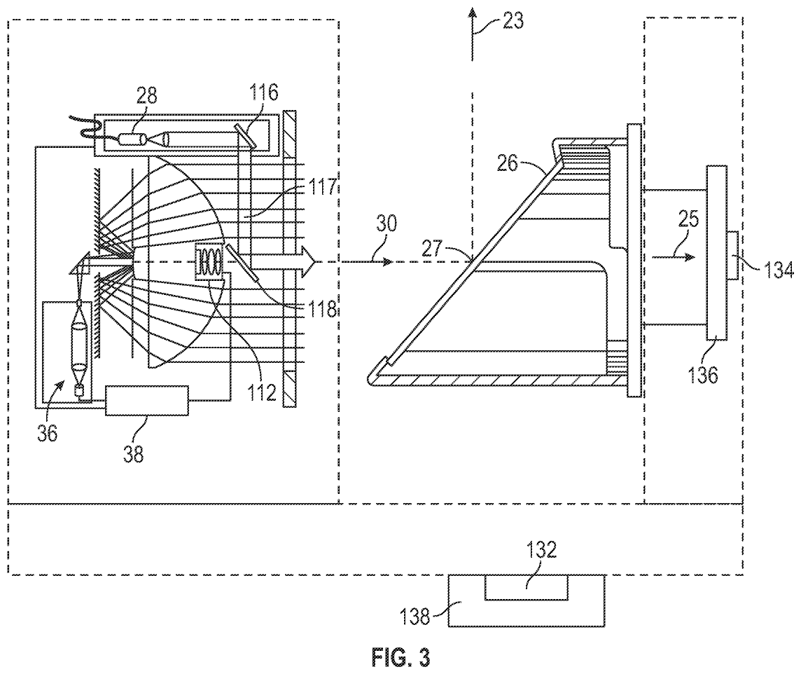

Referring now to FIGS. 1-3, a coordinate measurement device, such as a laser scanner 20, is depicted for optically scanning and measuring the environment surrounding the laser scanner 20. The laser scanner 20 has a measuring head 22 and a base 24. The measuring head 22 is mounted on the base 24 such that the laser scanner 20 may be rotated about a vertical axis 23. In one embodiment, the measuring head 22 includes a gimbal point 27 that is a center of rotation about the vertical axis 23 and a horizontal axis 25. The measuring head 22 has a rotary mirror 26, which may be rotated about the horizontal axis 25. The rotation about the vertical axis may be about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the scanner 20 may also collect gray-scale information related to the received optical power (equivalent to the term “brightness”). The gray-scale value may be determined at least in part, for example, by integration of the bandpass-filtered and amplified signal in the light receiver 36 over a measuring period attributed to the object point X.

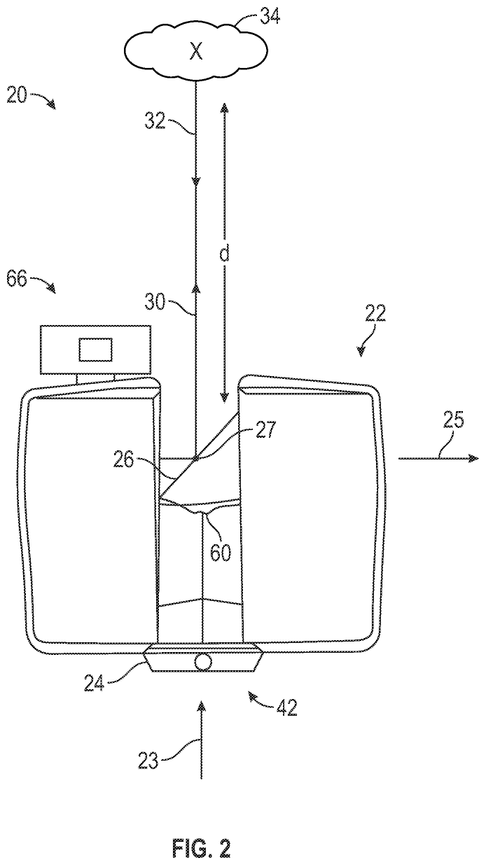

The measuring head 22 may include a display device 40 integrated into the laser scanner 20. The display device 40 may include a graphical touch screen 41, as shown in FIG. 2A, which allows the operator to set the parameters or initiate the operation of the laser scanner 20. For example, the screen 41 may have a user interface that allows the operator to provide measurement instructions to the device, and the screen may also display measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 may be coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 may include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d may depend on signal strength, which may be measured in optical power entering the scanner or optical power entering optical detectors within the light receiver 36, for example. In an embodiment, a distance correction is stored in the scanner as a function (possibly a nonlinear function) of distance to a measured point and optical power (generally unsealed quantity of light power sometimes referred to as “brightness”) returned from the measured point and sent to an optical detector in the light receiver 36. Since the prism 60 is at a known distance from the gimbal point 27, the measured optical power level of light reflected by the prism 60 may be used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 may be a device that captures and measures a parameter associated with the scanned area or the scanned object and provides a signal representing the measured quantities over an image acquisition area. The auxiliary image acquisition device 66 may be, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and may have the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 may be a near infrared laser light (for example, light at wavelengths of 780 nm or 1150 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 23 and by steering the mirror 26 about the axis 25.

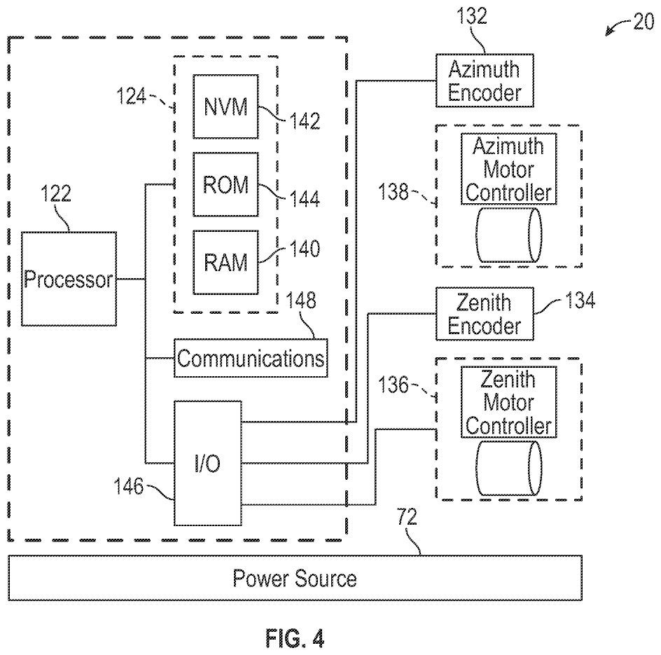

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. The processors may be microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 may be displayed on a user interface 40 coupled to controller 38. The user interface 40 may be one or more LEDs (light-emitting diodes), an LCD (liquid-crystal diode) display, a CRT (cathode ray tube) display, a touch-screen display or the like. A keypad may also be coupled to the user interface for providing data input to controller 38. In one embodiment, the user interface is arranged or executed on a mobile computing device that is coupled for communication, such as via a wired or wireless communications medium (e.g., Ethernet, serial, USB, Bluetooth™ or WiFi) for example, to the laser scanner 20.

The controller 38 may also be coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet(\hat{ }) Protocol), RS-232, ModBus, and the like. Additional systems may also be connected to LAN with the controllers 38 in each of these systems being configured to send and receive data to and from remote computers and other systems. The LAN may be connected to the Internet. This connection allows controller 38 to communicate with one or more remote computers connected to the Internet.

The processors 122 are coupled to memory 124. The memory 124 may include random access memory (RAM) device 140, a non-volatile memory (NVM) device 142, and a read-only memory (ROM) device 144. In addition, the processors 122 may be connected to one or more input/output (I/O) controllers 146 and a communications circuit 148. In an embodiment, the communications circuit 148 provides an interface that allows wireless or wired communication with one or more external devices or networks, such as the LAN discussed above.

Controller 38 includes operation control methods embodied in application code. These methods are embodied in computer instructions written to be executed by processors 122, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C #, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while some embodiments herein describe a point cloud that is generated by a TOF scanner, this is for example purposes and the claims should not be so limited. In other embodiments, the point cloud may be generated or created using other types of scanners, such as but not limited to triangulation scanners, area scanners, structured-light scanners, laser line scanners, flying dot scanners, and photogrammetry devices for example.

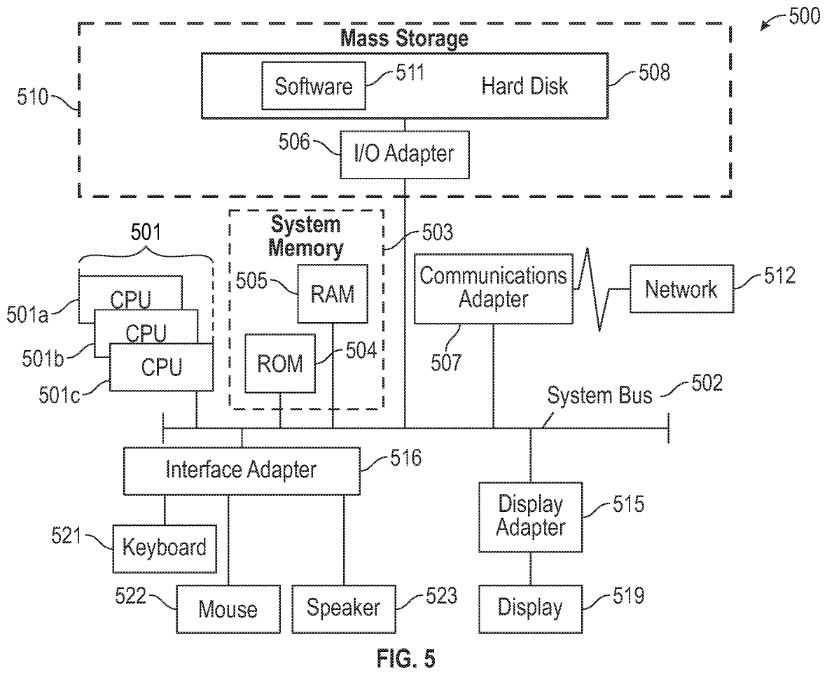

Turning now to FIG. 5, a computer system 500 is generally shown in accordance with one or more embodiments of the invention. The computer system 500 can be an electronic, computer framework comprising and/or employing any number and combination of computing devices and networks utilizing various communication technologies, as described herein. The computer system 500 can be easily scalable, extensible, and modular, with the ability to change to different services or reconfigure some features independently of others. The computer system 500 can be, for example, a server, desktop computer, laptop computer, tablet computer, or smartphone. In some examples, computer system 500 can be a cloud computing node. Computer system 500 can be described in the general context of computer system executable instructions, such as program modules, being executed by a computer system. Generally, program modules can include routines, programs, objects, components, logic, data structures, and so on that perform particular tasks or implement particular abstract data types. Computer system 500 can be practiced in distributed cloud computing environments where tasks are performed by remote processing devices that are linked through a communications network. In a distributed cloud computing environment, program modules can be located in both local and remote computer system storage media including memory storage devices.

As shown in FIG. 5, the computer system 500 has one or more central processing units (CPU(s)) 501a, 501b, 501c, etc., (collectively or generically referred to as processor(s) 501). The processors 501 can be a single-core processor, multi-core processor, computing cluster, or any number of other configurations. The processors 501, also referred to as processing circuits, are coupled via a system bus 502 to a system memory 503 and various other components. The system memory 503 can include a read only memory (ROM) 504 and a random access memory (RAM) 505. The ROM 504 is coupled to the system bus 502 and can include a basic input/output system (BIOS) or its successors like Unified Extensible Firmware Interface (UEFI), which controls certain basic functions of the computer system 500. The RAM is read-write memory coupled to the system bus 502 for use by the processors 501. The system memory 503 provides temporary memory space for operations of said instructions during operation. The system memory 503 can include random access memory (RAM), read only memory, flash memory, or any other suitable memory systems.

The computer system 500 comprises an input/output (I/O) adapter 506 and a communications adapter 507 coupled to the system bus 502. The I/O adapter 506 can be a small computer system interface (SCSI) adapter that communicates with a hard disk 508 and/or any other similar component. The I/O adapter 506 and the hard disk 508 are collectively referred to herein as a mass storage 510.

Software 511 for execution on the computer system 500 can be stored in the mass storage 510. The mass storage 510 is an example of a tangible storage medium readable by the processors 501, where the software 511 is stored as instructions for execution by the processors 501 to cause the computer system 500 to operate, such as is described herein below with respect to the various Figures. Examples of computer program product and the execution of such instruction is discussed herein in more detail. The communications adapter 507 interconnects the system bus 502 with a network 512, which can be an outside network, enabling the computer system 500 to communicate with other such systems. In one embodiment, a portion of the system memory 503 and the mass storage 510 collectively store an operating system, which can be any appropriate operating system to coordinate the functions of the various components shown in FIG. 5.

Additional input/output devices are shown as connected to the system bus 502 via a display adapter 515 and an interface adapter 516. In one embodiment, the adapters 506, 507, 515, and 516 can be connected to one or more I/O buses that are connected to the system bus 502 via an intermediate bus bridge (not shown). A display 519 (e.g., a screen or a display monitor) is connected to the system bus 502 by the display adapter 515, which can include a graphics controller to improve the performance of graphics intensive applications and a video controller. A keyboard 521, a mouse 522, a speaker 523, etc., can be interconnected to the system bus 502 via the interface adapter 516, which can include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 5, the computer system 500 includes processing capability in the form of the processors 501, storage capability including the system memory 503 and the mass storage 510, input means such as the keyboard 521 and the mouse 522, and output capability including the speaker 523 and the display 519.

In some embodiments, the communications adapter 507 can transmit data using any suitable interface or protocol, such as the internet small computer system interface, among others. The network 512 can be a cellular network, a radio network, a wide area network (WAN), a local area network (LAN), or the Internet, among others. An external computing device can connect to the computer system 500 through the network 512. In some examples, an external computing device can be an external webserver or a cloud computing node.

It is to be understood that the block diagram of FIG. 5 is not intended to indicate that the computer system 500 is to include all of the components shown in FIG. 5. Rather, the computer system 500 can include any appropriate fewer or additional components not illustrated in FIG. 5 (e.g., additional memory components, embedded controllers, modules, additional network interfaces, etc.). Further, the embodiments described herein with respect to computer system 500 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

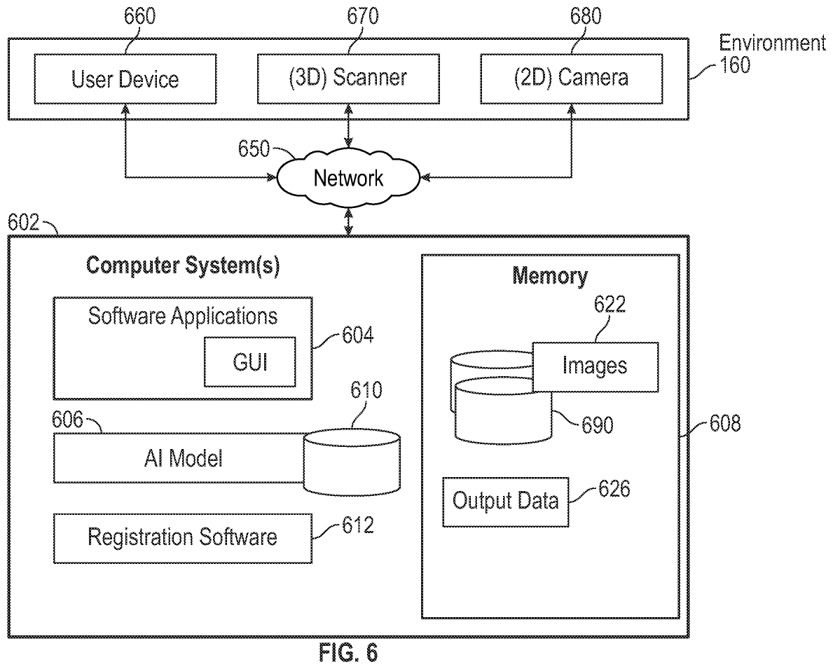

FIG. 6 is a block diagram of a computer system 602 for removing reflection artifacts from point clouds using artificial intelligence according to one or more embodiments. Elements of computer system 500 may be used in and/or integrated in computer system 602 and user device 660. An environment 160 may include a scanner 670 such as the laser scanner 20 discussed in FIGS. 1, 2, 3, and 4 and/or another suitable three-dimensional coordinate scanning device. The environment 160 may include a camera 680, for example, having features of the cameras 66, 112 of laser scanner 20 depicted in FIGS. 1-4 and/or another suitable camera. The scanner 670 is configured to measure three-dimensional coordinates of points in the environment or on an object. The scanner 670 may be a time-of-flight scanner, a triangulation scanner, an area scanner, a structured light scanner, or a laser tracker for example.

Data 690 in memory 608 can include 3D point clouds of the environment 160, also referred to as 3D point cloud data, point clouds, 3D images, etc. The 3D point cloud includes 3D point cloud data points. Data 690 in memory 608 may include 2D images of the environment 160. In an embodiment, the 2D images can include panorama images acquired while performing photogrammetry at a scene in the environment 160. Software application 604 can be used with, integrated in, call, and/or be called by other software applications, such as AI model 606, registration software 612, photogrammetry software, etc., for processing 3D point cloud data and 2D images as understood by one of ordinary skill in the art.

In one or more embodiments, software application 604 can be employed by a user for processing and manipulating 2D images and 3D point cloud data using a user interface such as, for example, a keyboard, mouse, touch screen, stylus, etc. Software application 604 can include and/or work with a graphical user interface (GUI), and features of the software application 604 can receive the output from the AI model 606 (e.g., a machine learning model) to remove reflection artifacts from 3D point cloud data as discussed herein. As understood by one of ordinary skill in the art, software application 604 includes functionality and/or is integrated with other software for processing any 2D image and 3D image including a 3D point cloud. In one or more embodiments, the software application 604 can include features of, be representative of, and/or be implemented in FARO® Zone 2D Software, FARO® Zone 3D Software, FARO® PhotoCore Software, and/or FARO® Scene Software, all of which are provided by FARO® Technologies, Inc.

Photogrammetry is a technique for modeling objects using images, such as photographic images acquired by a digital camera for example. Photogrammetry can make 3D models from 2D images or photographs. When two or more images are acquired at different positions that have an overlapping field of view, common points or features may be identified on each image. By projecting a ray from the camera location to the feature/point on the object, the 3D coordinate of the feature/point may be determined using trigonometry or triangulation. In some examples, photogrammetry may be based on markers/targets (e.g., lights or reflective stickers) or based on natural features. To perform photogrammetry, for example, images are captured, such as with a camera (e.g., the camera 680) having a sensor, such as a photosensitive array for example. By acquiring multiple images of an object, or a portion of the object, from different positions or orientations, 3D coordinates of points on the object may be determined based on common features or points and information on the position and orientation of the camera when each image was acquired. In order to obtain the desired information for determining 3D coordinates, the features are identified in two or more images. Since the images are acquired from different positions or orientations, the common features are located in overlapping areas of the field of view of the images. It should be appreciated that photogrammetry techniques are described in commonly-owned U.S. Pat. No. 10,597,753, the contents of which are incorporated by reference herein. With photogrammetry, two or more images are captured and used to determine 3D coordinates of features.

The various components, modules, engines, etc., described regarding the computer system 602, the user device 660, the scanner 670, and the camera 680 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the computer system 602 for executing those instructions. Thus, a system memory (e.g., the memory 608) can store program instructions that when executed by the computer system 602 implement the engines described herein. Other engines can also be utilized to include other features and functionality described in other examples herein.

A network adapter (not shown) provides for the computer system 602 to transmit data to and/or receive data from other sources, such as other processing systems, data repositories, and the like. As an example, the computer system 602 can transmit data to and/or receive data from the camera 680, the scanner 670, and/or the user device 660 directly and/or via a network 670.

The network 670 represents any one or a combination of different types of suitable communications networks such as, for example, cable networks, public networks (e.g., the Internet), private networks, wireless networks, cellular networks, or any other suitable private and/or public networks. Further, the network 670 can have any suitable communication range associated therewith and may include, for example, global networks (e.g., the Internet), metropolitan area networks (MANs), wide area networks (WANs), local area networks (LANs), or personal area networks (PANs). In addition, the network 650 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The camera 680 can be a 2D camera or a 3D camera (RGBD or time-of-flight for example). The camera 680 captures an image (or multiple images), such as of an environment 160. The camera 680 transmits the images to the computer system 602. In one or more embodiments, the camera 680 encrypts the image before transmitting it to the computer system 602. Although not shown, the camera 680 can include components such as a processing device, a memory, a network adapter, and the like, which may be functionally similar to those included in the computer system 500, 602 as described herein.

In some examples, the camera 680 is mounted to a mobile base, which can be moved about the environment 160. In some examples, the camera 680 is disposed in or mounted to an unmanned aerial vehicle. In various examples, the camera 680 is mounted on a manned aerial vehicle and/or unmanned aerial vehicle, generally referred to as a drone. In some examples, the camera 680 is mounted to a fixture, which is user-configurable to rotate about a roll axis, a pan axis, and a tilt axis. In such examples, the camera 680 is mounted to the fixture to rotate about the roll axis, the pan axis, and the tilt axis. Other configurations of mounting options for the camera 680 also are possible.

A coordinate measurement device, such as scanner 670 for example, is any suitable device for measuring 3D coordinates or points in an environment, such as the environment 160, to generate data about the environment. The scanner 670 may be implemented as a TOF laser scanner 20. A collection of 3D coordinate points is sometimes referred to as a point cloud. According to one or more embodiments described herein, the scanner 670 is a three-dimensional (3D) laser scanner time-of-flight (TOF) coordinate measurement device. It should be appreciated that while embodiments herein may refer to a laser scanner, this is for example purposes and the claims should not be so limited. In other embodiments, other types of coordinate measurement devices or combinations of coordinate measurement devices may be used, such as but not limited to triangulation scanners, structured light scanners, laser line probes, photogrammetry devices, and the like. A 3D TOF laser scanner steers a beam of light to a non-cooperative target such as a diffusely scattering surface of an object. A distance meter in the scanner 670 measures a distance to the object, and angular encoders measure the angles of rotation of two axles in the device. The measured distance and two angles enable a processor in the scanner 670 to determine the 3D coordinates of the target.

A TOF laser scanner, such as the scanner 670, is a scanner in which the distance to a target point is determined based on the speed of light in air between the scanner and a target point. Laser scanners are typically used for scanning closed or open spaces such as interior areas of buildings, industrial installations, and tunnels. They may be used, for example, in industrial applications and accident reconstruction applications. A laser scanner, such as the scanner 670, optically scans and measures objects in a volume around the scanner 670 through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected and stored as a point cloud, which can be transmitted to the computer system 602 and stored in the database 690 about the environment 160.

In some examples, the scanner 670 is mounted to a mobile base, which can be moved about the environment 160. In some examples, the scanner 670 is disposed in or mounted to an unmanned aerial vehicle. In various examples, the scanner 670 is mounted on a manned aerial vehicle and/or unmanned aerial vehicle, generally referred to as a drone. In some examples, the scanner 670 is mounted to a fixture, which is user-configurable to rotate about a roll axis, a pan axis, and a tilt axis. In such examples, the scanner 670 is mounted to the fixture to rotate about the roll axis, the pan axis, and the tilt axis. Other configurations of mounting options for the scanner 670 also are possible.

According to one or more embodiments described herein, the camera 680 captures 2D image(s) of the environment 160 and the scanner 670 captures 3D information of the environment 160. In some examples, the camera 680 and the scanner 670 are separate devices; however, in some examples, the camera 680 and the scanner 670 are integrated into a single device. For example, the camera 680 can include depth acquisition functionality and/or can be used in combination with a 3D acquisition depth camera, such as a time of flight camera, a stereo camera, a triangulation scanner, LIDAR, and the like. In some examples, 3D information can be measured/acquired/captured using a projected light pattern and a second camera (or the camera 680) using triangulation techniques for performing depth determinations. In some examples, a time-of-flight (TOF) approach can be used to enable intensity information (2D) and depth information (3D) to be acquired/captured. The camera 680 can be a stereo-camera to facilitate 3D acquisition. In some examples, a 2D image and 3D information (i.e., a 3D data set) can be captured/acquired at the same time; however, the 2D image and the 3D information can be obtained at different times.

The user device 660 (e.g., a smartphone, a laptop or desktop computer, a tablet computer, a wearable computing device, a smart display, and the like) can also be located within or proximate to the environment 160. The user device 660 can display an image of the environment 160, such as on a display of the user device 660 (e.g., the display 519 of the computer system 500 of FIG. 5) along with a digital visual element. In some examples, the user device 660 can include components such as a processor, a memory, an input device (e.g., a touchscreen, a mouse, a microphone, etc.), an output device (e.g., a display, a speaker, etc.), and the like.

Technical solutions described herein facilitate the automatic removal of reflection-induced artifacts from a point cloud. One or more embodiments disclose the application of AI based object detection techniques for removing reflection artifacts (as a result of windows, mirrors, and other reflective surfaces) from point clouds, which is beneficial for obtaining good registration results. Typically, a user has to manually select these noisy points in the point cloud and remove them, which is laborious and time consuming. One or more embodiments use an AI model to aid laser scanner users. Particularly, the system can use a neural network such as deep learning and teach the neural network to detect reflective surfaces (e.g., windows, glasses, mirrors, etc.) in the scene. With the reflective surfaces detected, the system identifies the noisy 3D points in a 3D space such as a 3D point cloud and deletes the noisy 3D points from the 3D point cloud, thereby resulting in a clean 3D point cloud. Two or more clean 3D point clouds are combined during registration, which would otherwise be difficult if the noisy 3D points were not removed.

Registration is a component in the laser scanning and post processing workflow. Registration, point cloud registration, or scan matching is the process of finding a spatial transformation (e.g., scaling, rotation, and translation) that aligns two point clouds. Moreover, registration is the process of aligning two or more 3D point clouds of the same scene into a common coordinate system. The purpose of finding such a transformation includes merging multiple data sets into a globally consistent model or coordinate frame and mapping a new measurement to a known data set to identify features or to estimate its pose. Scanning an environment consisting of reflective surfaces (such as, e.g., windows, mirrors, etc.) results in very noisy point clouds which make it necessary for the user to remove these noisy points first, in order to have good registration results. In typical scenarios, there are more than 30, 50, or 100 scans per project, and manually cleaning the artifacts in all these scans requires enormous time and effort as noted herein. Accordingly, automatic cleanup of these noisy 3D points is provided using one or more embodiments.

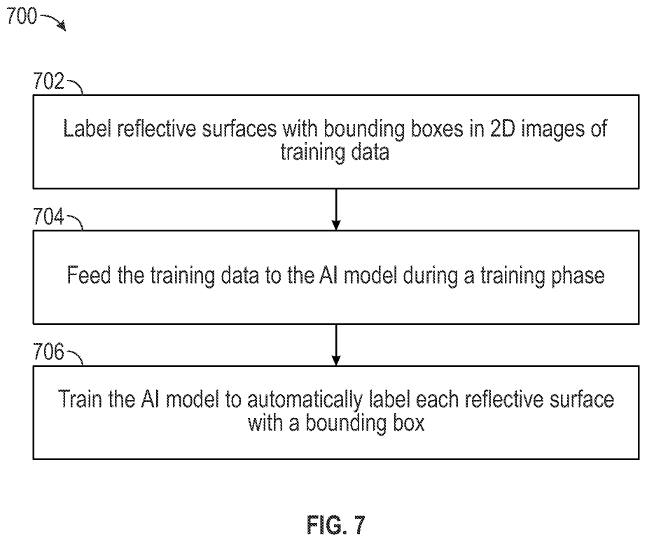

FIG. 7 depicts a flowchart of a computer-implemented method 700 for training an artificial intelligence (AI) model for detecting and generating a bounding box around reflective surfaces according to one or more embodiments. The AI model 606 can be used in computer system 602 to detect/identify reflective surfaces in 2D images and then generate a bounding box around each detected reflective surface. The bounding box has bounding coordinates that encompass the reflective surface.

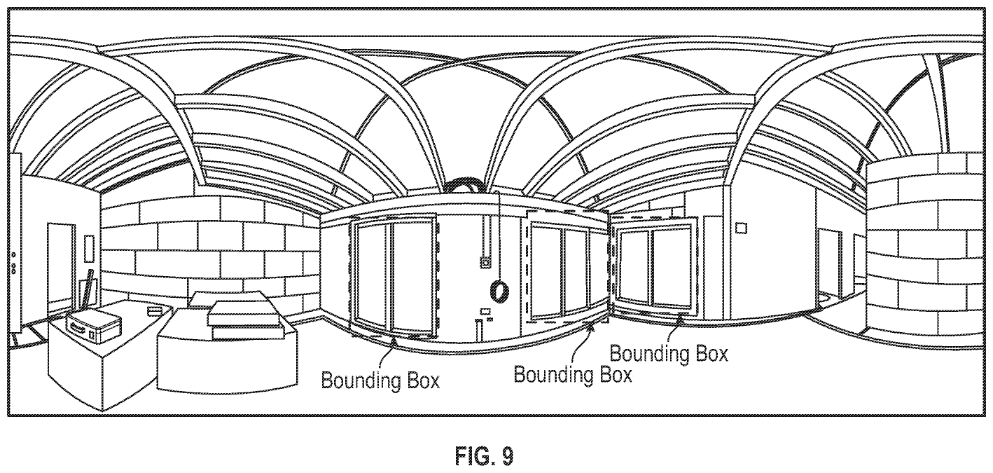

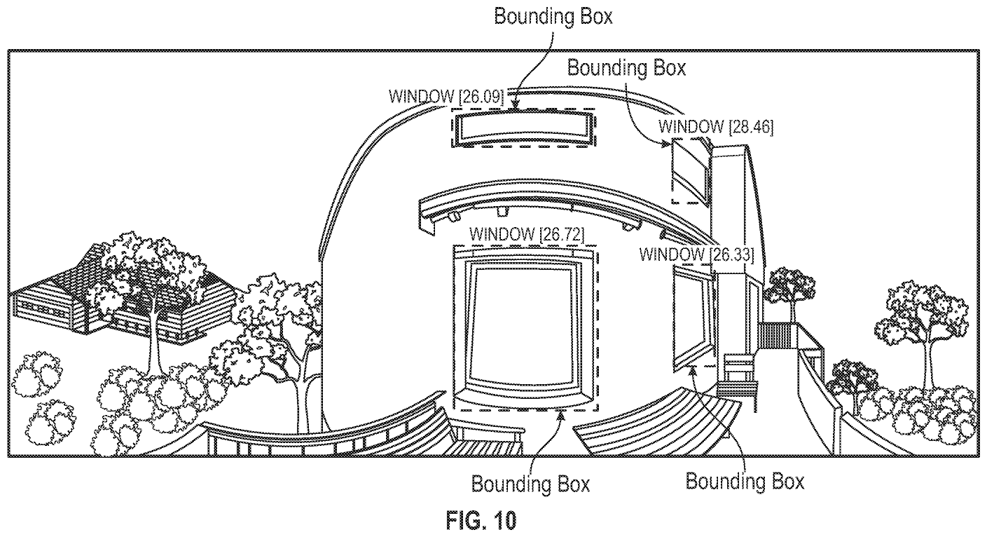

At block 702 of the computer-implemented method 700, 2D images are extracted and labelled to be utilized as labeled training data 610. At block 704 of the computer-implemented method 700, the AI model 606 is input/fed to the labeled training data 610 during the training phase. The labeled training data 610 includes RGB 2D color images with bounding boxes around each reflective surface, such as windows, mirrors, etc., that is to be removed. The labeled 2D color images along with intensity information from the scanner is used to train the AI model 606. In particular, grayscale intensity information (i.e., reflectance) can be fed with the labeled 2D color images to train the AI model to learn to detect and draw bounding boxes around the reflective surfaces. The grayscale intensity information serves as an extra input signal which helps the AI model generalize better, because the grayscale intensity information provides beneficial structural information. In one or more embodiments, both the labeled RGB color image and its corresponding (identical) grayscale/reflectance image can be fed to the AI model 606 for training. For example, FIG. 9 illustrates an example RGB color image having reflective surfaces each labeled with a bounding box according to one or more embodiments. In this example, as an example of training data 610, FIG. 9 illustrates annotated windows with (yellow) bounding boxes encompassing the reflective surfaces. FIG. 10 illustrates an example RGB color image having each reflective surface labeled with a bounding box according to one or more embodiments. FIG. 10 illustrates annotated windows with (orange) bounding boxes as training data. The AI model 606 was trained with RGB 2D panoramas but other color 2D images may be utilized for training.

At block 706 of the computer-implemented method 700, the AI model 606 analyzes the labeled images in the training data 610 to learn the reflective surfaces that are to be classified or labeled and correspondingly draws bounding boxes around the detected reflective surfaces. Moreover, after training the AI model 606, the software application 604 can feed an unlabeled RGB color image and the intensity information for that RGB color image to the AI model 606, and the AI model 606 is trained to draw bounding boxes around the reflective surfaces (if present) in the RGB color image. As such, AI model 606 has been trained to detect and label the reflective surfaces depicted in FIGS. 9 and 10.

In one or more embodiments, the AI model 606 is a machine learning engine such as an artificial neural network inference engine or a deep learning engine for example. AI model 606 is trained to produce a machine that exhibits characteristics associated with human intelligence, such as language comprehension, problem solving, pattern recognition, learning, and reasoning from incomplete or uncertain information. As a result of the training phase, the AI model 606 is now trained to detect reflective surfaces in a 2D image and classify/label the detected reflective surfaces with a bounding box where the 2D images have been captured using the camera 680, scanner 670, and/or any other suitable device.

In one or more embodiments, the AI model 606 can include various engines/classifiers and/or can be implemented on a neural network. The features of the engines/classifiers can be implemented by configuring and arranging the computer system 602 to execute machine learning algorithms. In general, machine learning algorithms, in effect, extract features from received data (e.g., inputs of 2D images) in order to “classify” the received data. Examples of suitable classifiers include but are not limited to neural networks, support vector machines (SVMs), logistic regression, decision trees, hidden Markov Models (HIVIMs), etc. The end result of the classifier's operations, i.e., the “classification,” is to predict a class for the data. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In one or more embodiments, the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Neural networks are usually created with base networks and based on requirements. Example base networks utilized include RESNET50, RESNET 10, Xception. It should be appreciated that other base network could be utilized for images. After the creation of the neural network, the dataset (training and testing) is fed to the model with the specific loss function and the training is started. Training consists of different hyperparameters that need to be set in order to achieve better accuracy. The dataset that is fed into the deep learning model is processed, and this called data preparation and augmentation. For illustration and not limitation, the training datasets 610 include 2D panoramas (i.e., images) with labeled windows, mirrors, glass or glass surfaces, glass doors, windows of vehicles, etc. Supervised learning was utilized in which the 2D images were manually labeled and fed to the neural network.

The raw dataset is collected and sorted manually. The sorted dataset can be labeled (e.g., using the Amazon Web Services® (AWS®) labeling tool such as Amazon SageMaker® Ground Truth). The labeling tool creates labeled images. The labeled images and unsorted images may be sorted in order to achieve data balancing and divided into training, testing, and validation datasets. Training and validation are used for training and evaluation, while testing is used after training to test the machine learning model on an unseen dataset. The training dataset may be processed through different data augmentation techniques. Training takes the labeled datasets, base networks, loss functions, and hyperparameters. Once these are all created and compiled, the training of the neural network occurs to eventually result in the trained machine learning model. Once the model is trained, the model (including the adjusted weights) is saved to a file for deployment and/or further testing on the test dataset.

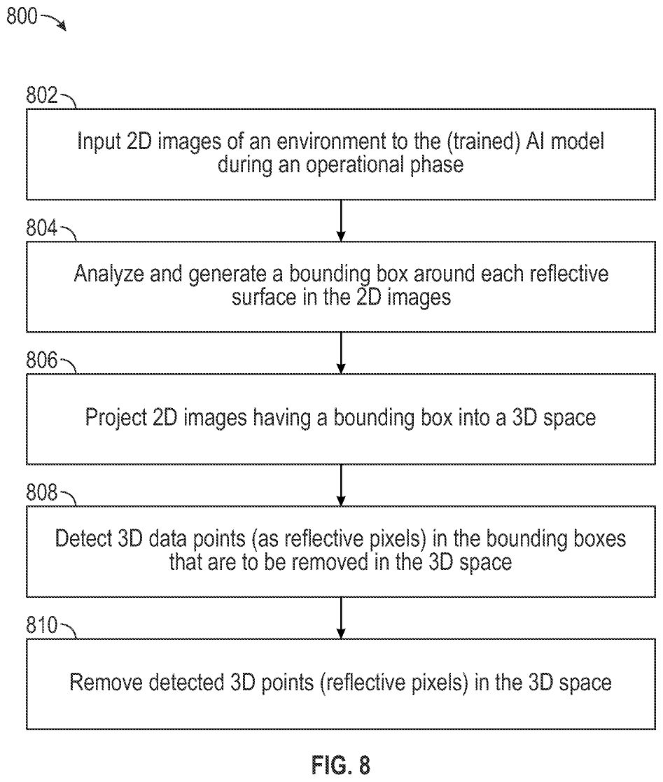

FIG. 8 depicts a flowchart of a computer-implemented method 800 for automatically removing reflection artifacts from a 3D image according to one or more embodiments. During an operational phase (i.e., normal operation of the AI model 606), the computer system 602 can use the boundary box surrounding the reflective surface to filter reflection artifacts from a 3D point cloud. In other words, when the reflection artifact is determined in the 3D point cloud, the corresponding 3D coordinate points from the point cloud are removed. As noted herein, the data 690 includes 3D point clouds and 2D images of the (same) environment 160.

At block 802 of the computer-implemented method 800, the software application 604 is configured to input color 2D images and their associated intensity information (i.e., reflectance values) of the environment 160 to the (trained) AI model 606 during an operational phase, which generates output data 626. A grayscale image or reflectance image comprises intensity information or reflectance values. Each pixel of the color 2D images includes intensity data and may further include depth data. Depth data is also referred to as range values or distance values.

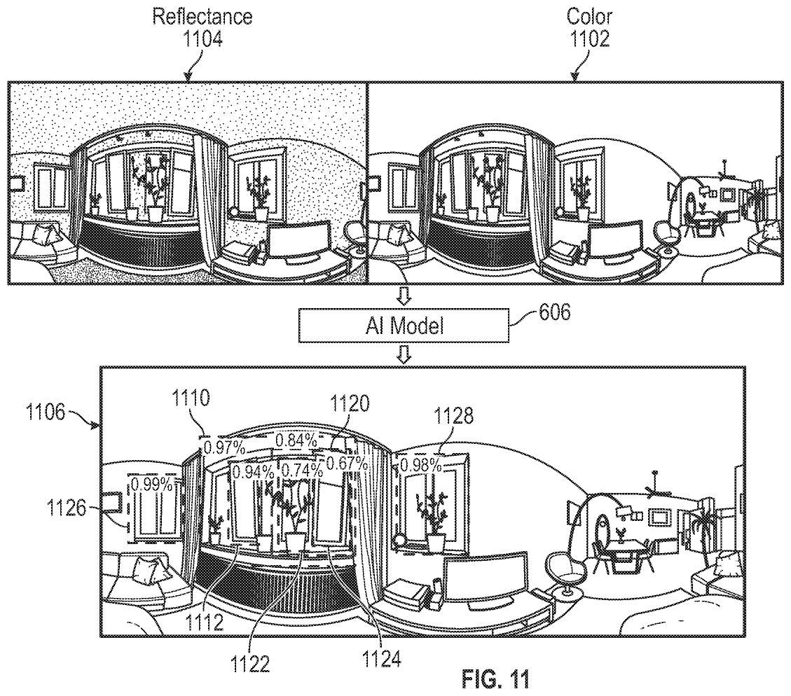

At block 804, the software application 604 is configured to receive the output data 626 from the AI model 606 in which the output data 626 includes the 2D images annotated with bounding boxes respectively encompassing each of the reflective surfaces. The AI model 606 detects each reflective surface in the 2D images and generates a bounding box around each of the reflective surfaces in a 2D image. FIG. 11 is an example illustrating an RGB 2D color image 1102 and intensity information 1104 (e.g., a grayscale/reflectance image of the RGB color image) input to the AI model 606, which generates bounding boxes encompassing the reflective surfaces in the RGB color image 1106 as the output data. As seen in RGB color image 1106, a large bounding box 1110 encompasses a large reflective surface which is a large window. There are smaller size bounding boxes surrounding smaller sections of the large window. For example, bounding box 1112 encompasses a smaller section of the large window. Within the large bounding box, there is a medium bounding box 1120 that encompasses a medium size section of the large window. Within the medium bounding box 1120, there are two smaller bounding boxes 1122, 1124 each encompassing a smaller section of the portion of the large window within the medium bounding box 1120. Other bounding boxes 1126, 1128 are also present. Each of the bounding boxes has its own bounding coordinates that form the box. Each bounding box is further processed to determine reflection artifacts (and/or reflective points) which are to be removed.

At block 806, the software application 604 is configured to project each of the 2D images having a bounding box of a reflective surface into a 3D space, such as a 3D point cloud of the environment 160. The bounding box in the 2D image is projected to the corresponding location in the 3D point cloud. Various projection techniques can used to project 2D images into a 3D coordinate system of the same environment as known by one of ordinary skill in the art. An example is forward projection. In one example of projection, the software application 604 (e.g., using one or more algorithms) is configured to use some available scan information. The 2D color images that are obtained from the scanner represents a spherical scan, where every row/column of the image is a coordinate in the spherical coordinate system with (phi, theta) values. The software application 604 can use these (phi, theta) values and the depth information to convert from the spherical coordinate system to the cartesian coordinate system (x, y, and z coordinates) and then locate the point in the 3D space.

At block 808, the software application 604 is configured to detect 3D data points (as reflective pixels) in the bounding boxes that are to be removed in the 3D space (e.g., 3D point cloud). At block 810, the software application 604 is configured to remove the detected 3D data points (e.g., reflective pixels) from the 3D space, for example, remove the (reflective) x, y, z data points from the 3D point cloud. Although an example for a single 3D point cloud is described, the computer-implemented method 800 is performed for multiple 3D point clouds of the environment 160 in data 690, such that each of the 3D point clouds having reflective pixels, which are the reflective 3D data points, are removed. These 3D point clouds can be more accurately be registered using registration software 612 or any suitable registration software, resulting in a single dense 3D point cloud without having to account for the reflective pixels. The reflective pixels can impede the registration because they are reflection artifacts that are not common across the multiple 3D point clouds of the environment.

Once the bounding boxes are drawn in the 2D image, the software application 604 can utilize multiple approaches to detect the actual pixels/scan data that needs to be removed in the 3D space. The software application 604 is configured to avoid removing all the points in the bounding box but to remove the 3D points that are visible on the reflective surface. A few example approaches that may utilized to detect and remove 3D data points may include 1) intensity data clustering and thresholding, 2) depth data clustering and thresholding, 3) defining rectangular view frustrum with the plane detection, and/or any suitable approach. In one or more embodiments, a combination of two more approaches may be utilized.

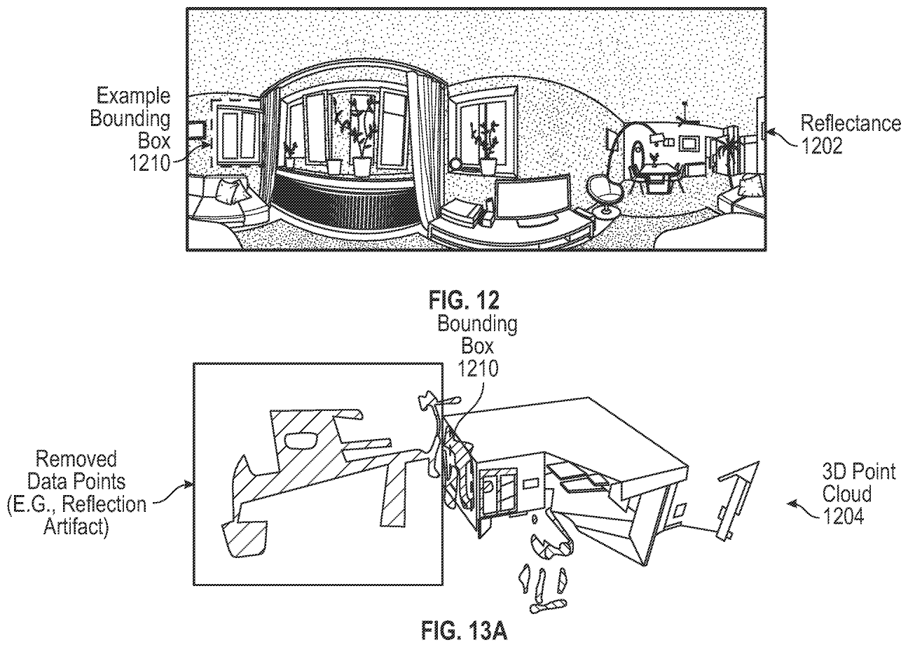

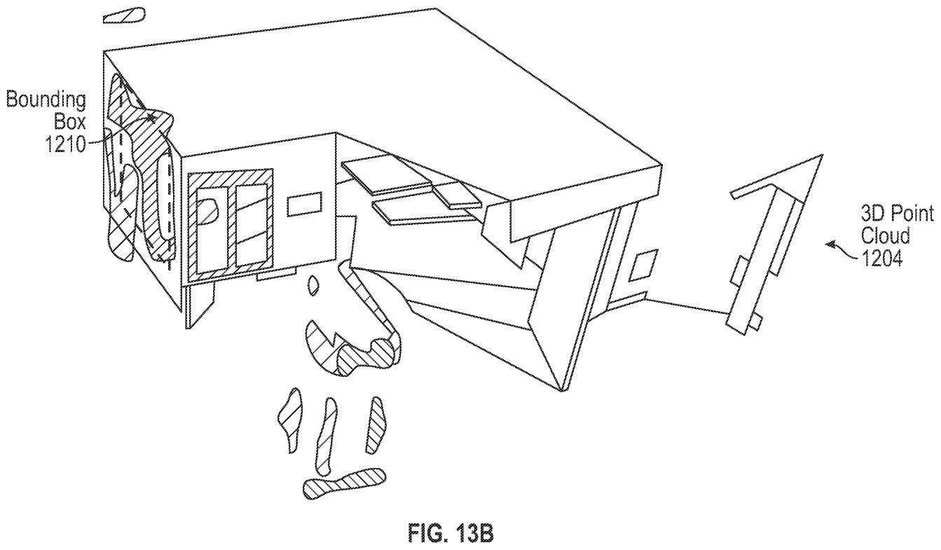

One approach for detecting 3D data points (as reflective pixels) in the bounding boxes is intensity data clustering and thresholding. The software application 604 is configured to pick the 3D data points inside the bounding box and apply a clustering technique to cluster the 3D data points based on their reflectance values. There is a cluster of 3D data points that correspond to the noisy pixels on the reflective surface as well as some clusters representing other 3D data points that lie within the bounding box (e.g., the window frame or some other object encapsulated by the bounding box). Since the reflectance at the surface of the reflective surface is lower as compared to the other areas encompassed by the bounding box, the software application 604 is configured to select the cluster of 3D data points with the lowest mean reflectance value and remove all these selected 3D data points. For example, the reflectance in the selected cluster is determined to be lower than a predefined reflectance threshold. As seen in FIG. 12, the reflectance image 1202 illustrates an example bounding box encompassing a window. In FIG. 12, it is visible that the reflectance on the reflective surfaces, such as inside the bounding box 1210 (and other windows), is lower (i.e., darker) than the reflectance of other areas. Accordingly, the 3D data points in the cluster having a mean reflectance value below the predefined reflectance threshold are selected from removal. Further, FIG. 13A illustrates a 3D point cloud 1204 of the same environment of FIG. 12. In FIG. 13A, it can be seen that, based on the thresholding concept, the software application 604 is configured to identify the 3D data points on the reflective surface (red) accurately without classifying the other points in the bounding box (green) as noisy/reflective surface points. The software application 604 is configured to remove the 3D data points on the reflective surface, which are below the reflectance value threshold, resulting in a 3D point cloud free of reflection artifacts for the identified bounding box, as depicted in FIG. 13B.

Another example approach for detecting 3D data points (as reflective pixels) in the bounding boxes is depth data clustering and thresholding. This approach is analogous to intensity data clustering and thresholding except the clustering and thresholding are for the depth data. For example, the software application 604 is configured to find and cluster points that have the highest mean depth value. The depth value corresponds to the distance value for a 3D data point, such as the distance/depth to the capturing device (e.g., the scanner 670). Accordingly, for any cluster of 3D data points that have a value or mean value greater than a predefined depth threshold, the 3D data points in these clusters are identified as reflection artifacts and are removed from the 3D point cloud, resulting in a 3D point cloud free of reflection artifacts.

Another example approach for detecting 3D data points (as reflective pixels) in the bounding boxes includes defining rectangular view frustrum with the plane detection. After the AI model 606 draws the bounding box on the reflective surface (window, mirror, television screen, etc.), since the software application 604 has the normal information for the 3D image available, the software application 604 is configured to fit a plane on the bounding box by considering the center point of the bounding box and the normal vector at the center. After that, the software application 604 to searches for the maximum depth within the bounding box and uses that information along with the angles that define the view frustrum. The software application 604 can fit a rectangular volume in the view frustrum and filter out all the points that are contained within the rectangular volume, thereby resulting in a 3D point cloud free of reflection artifacts.

Accordingly, embodiments disclosed herein describe a technique and system that can generate clear 3D coordinate scan data by filtering artifacts from the 3D coordinate scan data based on training an AI model to identify and draw a bounding box around each reflective surface in 2D images. Embodiments disclosed provide a technical effect of removing regions of 3D coordinate points in scan data related to a reflective surface captured in the 3D coordinate scan data by using the AI model that has been trained to detect the reflective surface and draw the bounding box around the detected reflective surface. The AI model learns to recognize reflective surfaces which are then enclosed in a bounding box, and the reflection artifacts (i.e., 3D data points) on and/or through the reflective surface are detected and filtered out using one or more of the approaches discussed herein. There can be multiple 3D point clouds generated for the same environment, and with the reflection artifacts removed, the multiple 3D point clouds can be registered and combined into a dense 3D point cloud of the environment.

Technical effects and benefits of the disclosed embodiments include, but are not limited to, increasing scan quality and a visual appearance of scans acquired by the 3D coordinate measurement device, thereby resulting in a quicker registration (i.e., combination) of 3D point clouds because the 3D points of reflection artifacts have been removed.

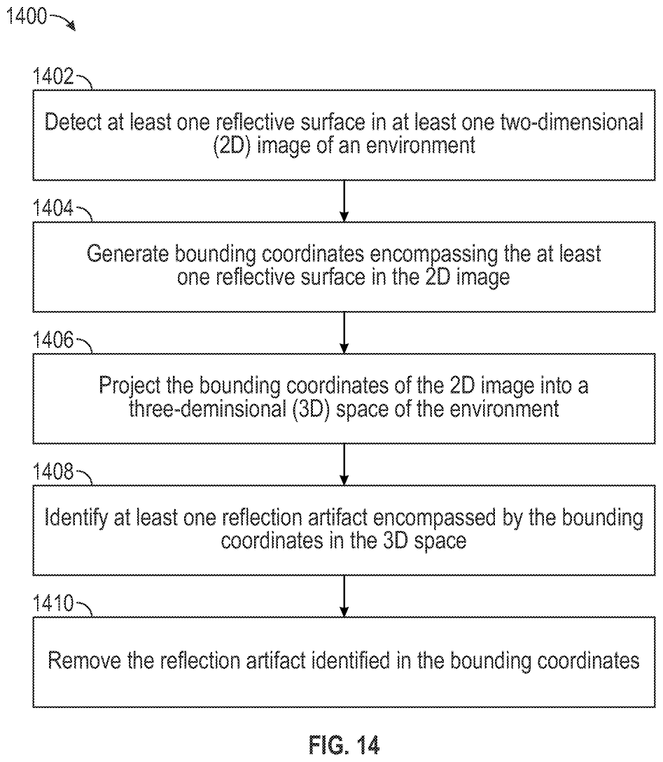

FIG. 14 depicts a flowchart of a computer-implemented method 1400 for automatically removing reflection artifacts from a 3D image using a 2D image according to one or more embodiments. The computer system 602 is configured to perform the computer-implemented method 1400.

At block 1402, the software application 604 is configured to detecting at least one reflective surface in at least one two-dimensional (2D) image of an environment 160. At block 1404, the software application 604 is configured to generate bounding coordinates (e.g., used to form a bounding box) encompassing the at least one reflective surface in the 2D image. At block 1406, the software application 604 is configured to project the bounding coordinates of the 2D image into a three-dimensional (3D) space of the environment 160. At block 1408, the software application 604 is configured to identify at least one reflection artifact encompassed by the bounding coordinates in the 3D space. At block 1410, the software application 604 is configured to remove the reflection artifact identified in the bounding coordinates. For example, the reflection artifacts are identified and removed in FIG. 13.

An artificial intelligence (AI) model 606 is trained to detect the at least one reflection artifact and generate the bounding coordinates encompassing the at least reflective surface. The AI model 606 is trained on a dataset 610 of a plurality of 2D images, the plurality of 2D images comprising a plurality of bounding coordinates (i.e., labels of reflective surfaces in 2D images) respectively encompassing a plurality of reflective surfaces.

Removing the reflection artifact identified in the bounding coordinates comprises: selecting candidate 3D points encompassed by the bounding coordinates in the 3D space, clustering the candidate 3D points by intensity values or reflectance values, and selecting at least one of the 3D points as the reflection artifact based at least in part on a threshold (e.g., a reflectance threshold) associated with the intensity values or the reflectance values. Removing the reflection artifact identified in the bounding coordinates comprises: selecting candidate 3D points encompassed by the bounding coordinates in the 3D space, clustering the candidate 3D points by depth values, and selecting at least one of the 3D points as the reflection artifact based at least in part on a threshold (e.g., depth/distance threshold) associated with the depth values. Removing the reflection artifact identified in the bounding coordinates comprises: fit a plane on the bounding coordinates by using a normal vector of a center point of the bounding coordinates, find a maximum depth within the bounding coordinates, and fit a rectangular volume using the maximum depth.

The 2D image is a panorama image. The 3D space is a 3D point cloud that is registered with at least one other 3D point cloud of the (same) environment 160. For example, the software application 604 may employ registration software 612 to register the cleaned 3D point cloud that had at least one reflection artifact removed with another 3D point cloud that had a reflection artifact removed or that did not have any reflection artifacts.

It will be appreciated that aspects of the present invention may be embodied as a system, method, or computer program product and may take the form of a hardware embodiment, a software embodiment (including firmware, resident software, micro-code, etc.), or a combination thereof. Furthermore, aspects of the present invention may take the form of a computer program product embodied in one or more computer readable medium(s) having computer readable program code embodied thereon.

One or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer readable storage medium may be a tangible medium containing or storing a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The computer readable medium may contain program code embodied thereon, which may be transmitted using any appropriate medium, including but not limited to wireless, wireline, optical fiber cable, RF, etc., or any suitable combination of the foregoing. In addition, computer program code for carrying out operations for implementing aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

It will be appreciated that aspects of the present invention are described herein with reference to flowchart illustrations and/or block diagrams of methods, apparatus (systems) and computer program products according to embodiments of the invention. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Terms such as processor, controller, computer, DSP, FPGA are understood in this document to mean a computing device that may be located within an instrument, distributed in multiple elements throughout an instrument, or placed external to an instrument.

While embodiments of the invention have been described in detail in connection with only a limited number of embodiments, it should be readily understood that embodiments of the invention are not limited to such disclosed embodiments. Rather, embodiments of the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, embodiments of the invention are not to be seen as limited by the foregoing description, but is only limited by the scope of the appended claims.

What is claimed is:

1. A computer-implemented method comprising:
detecting at least one reflective surface in at least one two-dimensional (2D) image of an environment;
generating bounding coordinates encompassing the at least one reflective surface in the 2D image;
projecting the bounding coordinates of the 2D image into a three-dimensional (3D) space of the environment;
identifying a reflection artifact encompassed by the bounding coordinates in the 3D space; and
removing the reflection artifact identified in the bounding coordinates.

2. The computer-implemented method of claim 1, wherein an artificial intelligence (AI) model is trained to detect the at least one reflection artifact and generate the bounding coordinates encompassing the at least one reflective surface.

3. The computer-implemented method of claim 1, wherein the AI model is trained on a dataset of a plurality of 2D images, the plurality of 2D images comprising a plurality of bounding coordinates respectively encompassing a plurality of reflective surfaces.

4. The computer-implemented method of claim 1, wherein removing the reflection artifact identified in the bounding coordinates comprises:
selecting candidate 3D points encompassed by the bounding coordinates in the 3D space;
clustering the candidate 3D points by intensity values or reflectance values; and
selecting at least one of the candidate 3D points as the reflection artifact based at least in part on a threshold associated with the intensity values or the reflectance values.

5. The computer-implemented method of claim 1, wherein removing the reflection artifact identified in the bounding coordinates comprises:
selecting candidate 3D points encompassed by the bounding coordinates in the 3D space;
clustering the candidate 3D points by depth values;
selecting at least one of the candidate 3D points as the reflection artifact based at least in part on a threshold associated with the depth values.

6. The computer-implemented method of claim 1, wherein removing the reflection artifact identified in the bounding coordinates comprises:
fit a plane on the bounding coordinates by using a normal vector of a center point of the bounding coordinates;
find a maximum depth within the bounding coordinates; and
fit a rectangular volume using the maximum depth.

7. The computer-implemented method of claim 1, wherein the 2D image is a panorama image.

8. The computer-implemented method of claim 1, wherein the 3D space is a 3D point cloud that is registered with at least one other 3D point cloud of the environment.

9. A system comprising:
a memory having computer readable instructions; and
one or more processors for executing the computer readable instructions, the computer readable instructions controlling the one or more processors to perform operations comprising:
detecting at least one reflective surface in at least one two-dimensional (2D) image of an environment;
generating bounding coordinates encompassing the at least one reflective surface in the 2D image;
projecting the bounding coordinates of the 2D image into a three-dimensional (3D) space of the environment;
identifying a reflection artifact encompassed by the bounding coordinates in the 3D space; and
removing the reflection artifact identified in the bounding coordinates.

10. The system of claim 9, wherein an artificial intelligence (AI) model is trained to detect the at least one reflection artifact and generate the bounding coordinates encompassing the at least one reflective surface.

11. The system of claim 9, wherein the AI model is trained on a dataset of a plurality of 2D images, the plurality of 2D images comprising a plurality of bounding coordinates respectively encompassing a plurality of reflective surfaces.

12. The system of claim 9, wherein removing the reflection artifact identified in the bounding coordinates comprises:
selecting candidate 3D points encompassed by the bounding coordinates in the 3D space;
clustering the candidate 3D points by intensity values or reflectance values; and
selecting at least one of the candidate 3D points as the reflection artifact based at least in part on a threshold associated with the intensity values or the reflectance values.

13. The system of claim 9, wherein removing the reflection artifact identified in the bounding coordinates comprises:
selecting candidate 3D points encompassed by the bounding coordinates in the 3D space;
clustering the candidate 3D points by depth values;
selecting at least one of the candidate 3D points as the reflection artifact based at least in part on a threshold associated with the depth values.

14. The system of claim 9, wherein removing the reflection artifact identified in the bounding coordinates comprises:
fit a plane on the bounding coordinates by using a normal vector of a center point of the bounding coordinates;
find a maximum depth within the bounding coordinates; and
fit a rectangular volume using the maximum depth.

15. The system of claim 9, wherein the 2D image is a panorama image.

16. The system of claim 9, wherein the 3D space is a 3D point cloud that is registered with at least one other 3D point cloud of the environment.

17. A computer program product comprising a computer readable storage medium having program instructions embodied therewith, the program instructions executable by one or more processors to cause the one or more processors to perform operations comprising:
detecting at least one reflective surface in at least one two-dimensional (2D) image of an environment;
generating bounding coordinates encompassing the at least one reflective surface in the 2D image;
projecting the bounding coordinates of the 2D image into a three-dimensional (3D) space of the environment;
identifying a reflection artifact encompassed by the bounding coordinates in the 3D space; and
removing the reflection artifact identified in the bounding coordinates.

18. The computer program product of claim 17, wherein an artificial intelligence (AI) model is trained to detect the at least one reflection artifact and generate the bounding coordinates encompassing the at least one reflective surface.

19. The computer program product of claim 17, wherein the AI model is trained on a dataset of a plurality of 2D images, the plurality of 2D images comprising a plurality of bounding coordinates respectively encompassing a plurality of reflective surfaces.

20. The computer program product of claim 17, wherein removing the reflection artifact identified in the bounding coordinates comprises:
selecting candidate 3D points encompassed by the bounding coordinates in the 3D space;
clustering the candidate 3D points by intensity values or reflectance values; and
selecting at least one of the candidate 3D points as the reflection artifact based at least in part on a threshold associated with the intensity values or the reflectance values.
